(19) United States
(12) Patent Application Publication
(10) Pub. No.: US 2026/0058407 A1
(43) Pub. Date: Feb. 26, 2026

(54) CARTRIDGE LOADED WITH ELECTRICAL CONNECTORS AND IMPROVED FLOATING MECHANISMS

(71) Applicant: FOXCONN INTERCONNECT TECHNOLOGY LIMITED, Grand Cayman (KY)

(72) Inventor: KUO-CHUN HSU, New Taipei (TW)

(21) Appl. No.: 19/238,714

(22) Filed: Jun. 16, 2025

Related U.S. Application Data
(60) Provisional application No. 63/686,410, filed on Aug. 23, 2024.

(51) Int. Cl. H01R 13/631

(52) U.S. Cl. CPC H01R 13/6315

(57) ABSTRACT

A cartridge includes: plural connector chambers arranged in a first axis; plural electrical connectors received in the connector chambers respectively, each of the electrical connectors having a mating axis, a connector housing, an array of conductive elements retained in the connector housing, and a mating guide immovably disposed on the connector housing; and at least one biasing assembly disposed behind each of the electrical connectors and pushing forwards the electrical connector in the mating axis, wherein the cartridge further includes plural guiding mechanisms each allowing a corresponding connector housing to move in the first axis and a second axis perpendicular to the first axis.

### CROSS REFERENCE TO RELATED APPLICATION

This application claims priority to and benefit of U.S. Provisional Patent Application No. 63/686,410 , filed Aug. 23, 2024, the content of which is incorporated entirely herein by reference.

### BACKGROUND OF THE INVENTION

### Field of the Invention

The present invention relates to a cartridge loaded with plural electrical connector and with floating mechanisms for aligned mate of the electrical connectors and mating electrical connectors, especially to an electrical connector assembled in a cartridge and connected with cables.

### Description of Related Arts

U.S. Patent Application Publication No. 2023/0187861 discloses a dense, high speed interconnection formed with a header connector and a mating receptacle connector. The header connector includes structural projections and the receptacle connector includes corresponding apertures receiving the structural projections in order to reduce damage to contact portions of the header connector.

U.S. Patent Application Publication No. 2024/0195116 disclose a connector assembly includes a connector holder having a frame including an upper frame member, a lower frame member, and first and second side frame members defining a connector chamber. The frame includes a rear frame member rearward of the connector chamber. The connector assembly includes a cable connector received in the connector chamber having a connector housing holding contact assemblies. The connector assembly includes a biasing member operably coupled between the cable connector and the rear frame member of the connector holder. The biasing member forward biases the cable connector and is compressible in a rearward compression direction to allow the cable connector to move rearward relative to the rear frame member.

Therefore, an improved floating mechanism is desired to overcome the disadvantages of the prior arts.

### SUMMARY OF THE INVENTION

An object of the present invention is to a cartridge loaded with electrical connector and a floating mechanism behind each of the electrical connectors.

In order to achieve above-mentioned object, a cartridge comprises: a plurality of connector chambers arranged in a first axis; a plurality of electrical connectors received in the connector chambers respectively, each of the electrical connectors having a mating axis and comprising a connector housing, an array of conductive elements retained in the connector housing, and a mating guide immovably disposed on the connector housing; and at least one biasing assembly disposed behind each of the electrical connectors and pushing forwards the electrical connector in the mating axis, wherein the cartridge further comprises plural guiding mechanisms, each of the guiding mechanisms allows a corresponding connector housing to move in the first axis and a second axis perpendicular to the first axis.

Other objects, advantages and novel features of the present invention will become more apparent from the following detailed description of the present embodiment when taken in conjunction with the accompanying drawings.

### BRIEF DESCRIPTION OF DRAWINGS

FIG. 1 is a perspective view of a tray with four receptacle connector and a cartridge with four plug connector according to a first embodiment of the present invention, wherein the tray is ready to mate with the cartridge;

FIG. 2 is a perspective view of the cartridge with the plug connectors;

FIG. 3 is a front perspective view of a part of a lower frame of the cartridge with one plug connector therein;

FIG. 4 is a rear perspective view of a part of a lower frame of the cartridge with one plug connector therein;

FIG. 5 is a rear perspective view of a part of a lower frame of the cartridge;

FIG. 6 is a perspective view of an upper frame of the cartridge;

FIG. 7 is a cross-sectional view of a part of the cartridge, showing a connector chamber, a front cavity and a rear cavity seen in a transverse axis;

FIG. 8 is a top view of a part of the plug in the cartridge with a floating mechanism in a front position to a rear position;

FIG. 9 is a front perspective view of the plug connector;

FIG. 10 is a rear perspective view of the plug connector;

FIG. 11 is a rear exploded perspective view of the plug connector;

FIG. 12 is a perspective view of four rods each with a nut, and four spring members;

FIG. 13 is a perspective view of a part of a plug connector and a receptacle during the mating process of a second embodiment;

FIG. 14 is a rear perspective view of a part of the tray and the cartridge of a third embodiment;

FIG. 15 is a plan view of FIG. 14;

FIG. 16 is a front perspective view of the plug connector in the cartridge of a fourth embodiment;

FIG. 17 is a rear perspective view of the plug connector in FIG. 16; and

FIG. 18 is a front perspective view of the plug connector of the fourth embodiment.

### DETAILED DESCRIPTION OF THE DRAWINGS

Reference will now be made to the drawing figures to describe the preferred embodiment of the present invention in detail.

The invention is related to a floating and centering mating mechanism for precisely positioning in order to align a plug connector and a receptacle connector.

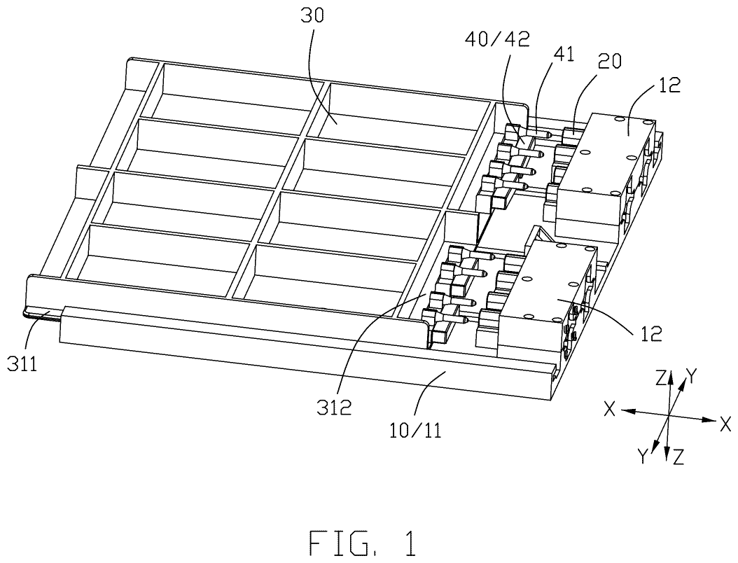

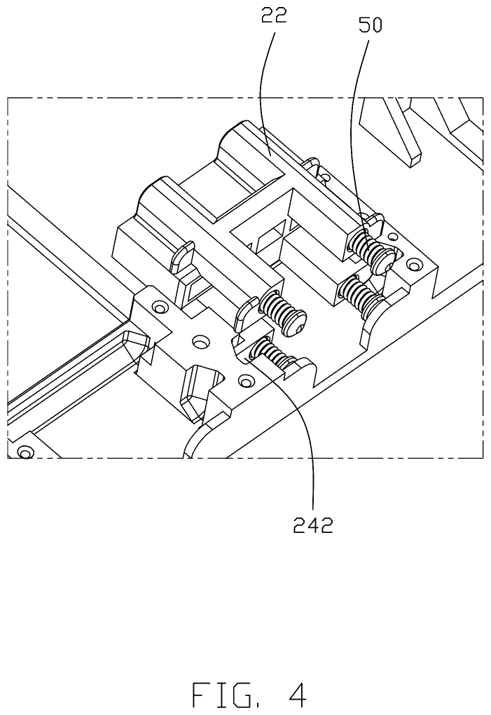

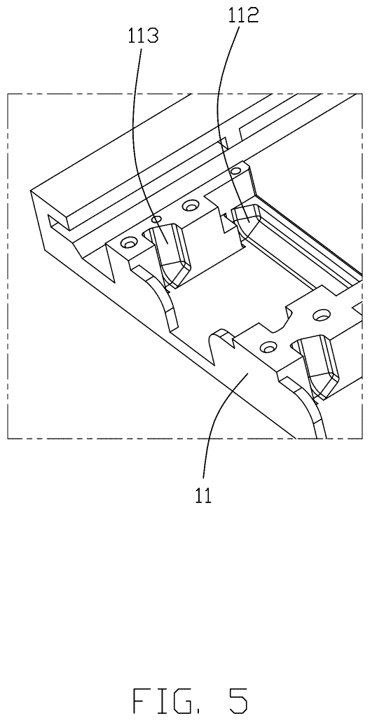

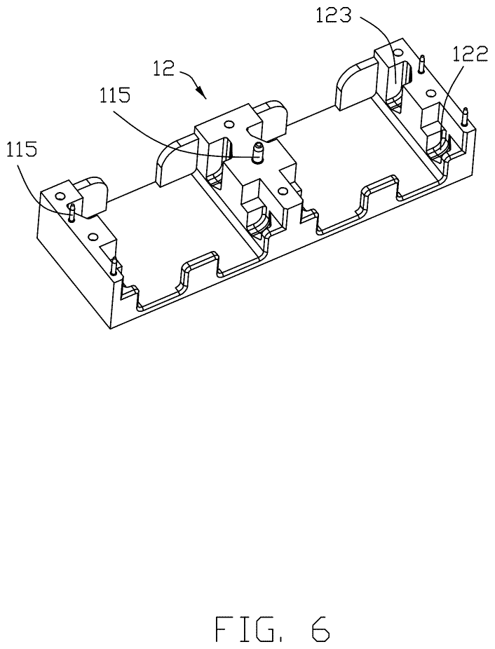

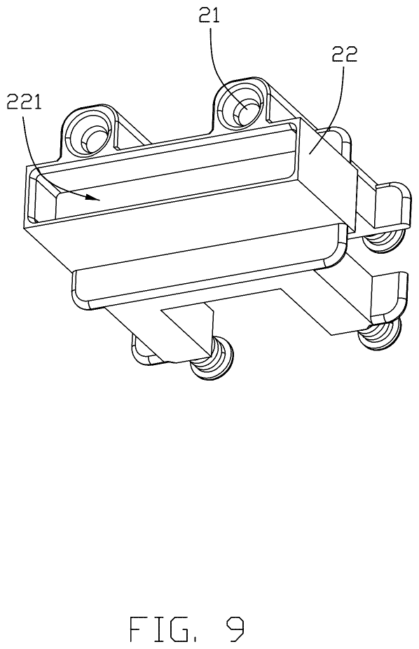

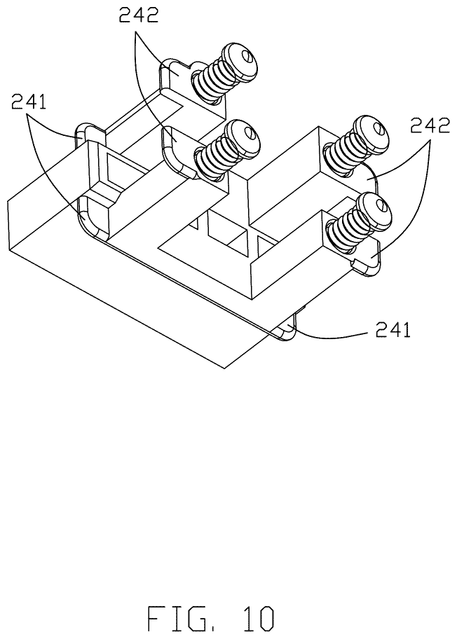

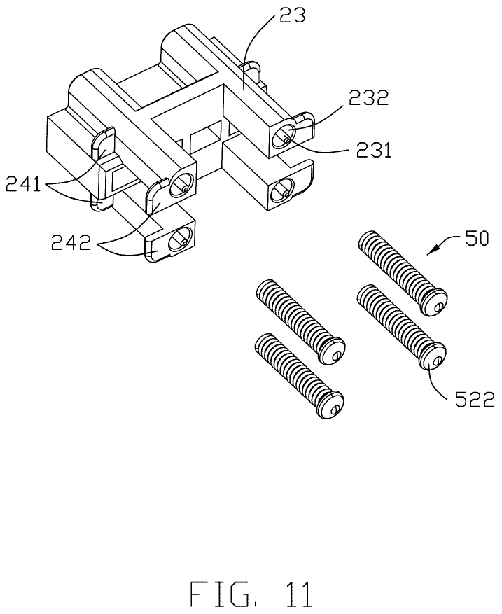

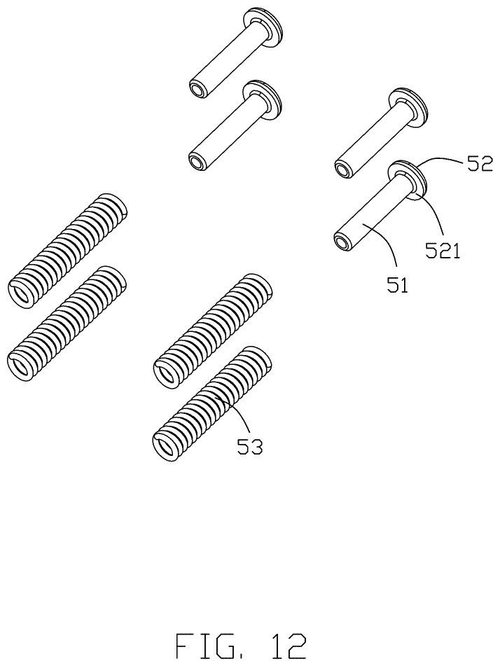

FIGS. 1-12 illustrate a first embodiment. In FIG. 1, the cartridge 10 is mounted with a plurality of electrical connectors, the electrical connector is a type of a plug connector 20 in this embodiment. It's noted that a base or lower frame 11 of the cartridge 10 is shown wholly, an upper frame 12 is partly shown, the upper frame 12 may be a part of the cartridge to co-operate with the lower frame 11 in some embodiments. The tray 30 is mounted with plural electrical connectors, the electrical connector is a type of a receptacle connector 40. The tray 40 slides into the cartridge 10 by opposite sliding ribs 311 on the tray 30 along sliding slots 111 on the cartridge 10 to form an apparatus used in a server rack. In this embodiment, four receptacle connectors 40 are mounted on a leading end 312 of the tray 30, the four receptacle connectors 30 come to engage with the four plug connectors 20 at a same time in a mating axis/a horizontal axis or the X-axis. The plug connector 20 is located at a cartridge side and the receptacle connector 40 is located at a tray side. The receptacle connectors 40 are immovably or rigidly retained at the leading end 312 of the tray 30. Usually the receptacle connectors 40 are mounted on a printed circuit received in the tray 30 so that the receptacle connectors 40 are immovably retained in the tray 30.

It is noted that for a connector housing 22 of the plug connector 20 disposed therein will be conductive elements which are omitted in the drawing figures, for simplicity and clarity. Similarly, conductive elements disposed in the receptacle connector 40 are omitted in the drawing figures where applicable. The plug connector 20 or the receptacle connector 40 has an array of conductive elements, such as conductive terminals retained in an insulating housing. The plug connector 20 may be a backplane connector, such as US20230187861 A1 shows. That is, the plug connector 20 has multiple conductive elements in a mating cavity 221. The receptacle connector 40 also has an array of conductive elements arranged in columns and rows.

The plug connector 20 is retained in the cartridge 10 and usually connected with cables extending out of the cartridge 10 to communicated with another electrical connector mounted on another cartridge. It's important that the plug connectors 20 in the cartridge 10 may float in three axes, in the mating axis or X-axis, a first axis or the Y-axis and a second axis or the Z-axis by a floating mechanism described thereinafter. The plug connectors 20 are guided to be mated with the receptacle connectors 40 in an acute position. Otherwise, the conductive elements in the plug connector or the receptacle connector will be destroyed.

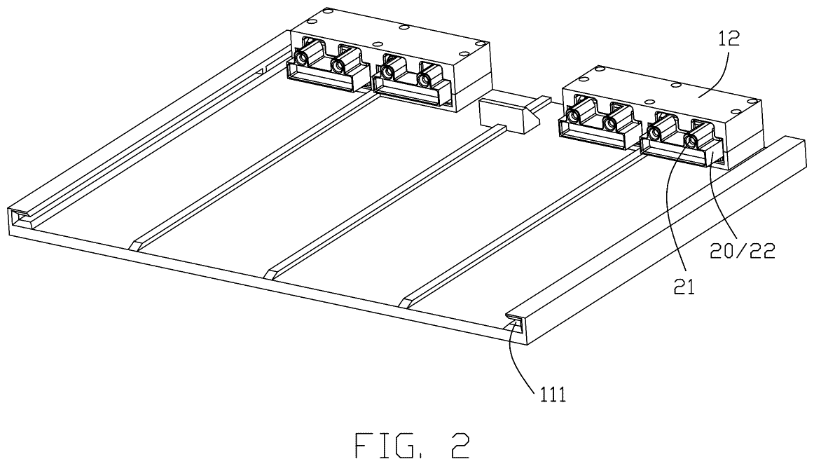

As shown in FIGS. 1-2, a mating guide is disposed on the connector/plug housing 22. In this embodiment, two guide holes 21 may be disposed on the plug connector 20 to define the mating guide. The guiding holes 21 are located at a side of the plug housing 22. In this embodiment, the guiding holes 21 are located at an upper side of the plug housing 22. Two guide pins 41 are disposed on the receptacle connector 40 to define a mating guide on the receptacle connector 40. The two guiding pins 41 are located at a side of the receptacle housing 42. In this embodiment, the guiding pins/holes may integrally extend from the connector housing 22. That means, the guiding pins/holes are made from insulating material. Compared with current guiding pins made from metal cast, the cost is lower. Moreover, the plug connector is guided to be constantly adjust its position so as to get a more precise positioning to secure the alignment of the plug connector and the receptacle connector based on the floating mechanism. The mating guides and the conductive elements of adjacent plug connectors are distinct from each other, the impact on each other are reduced. In alternative embodiment, the guiding pins may be metallic guiding pin, the metallic guiding pins are rigidly retained on the connector housing 22.

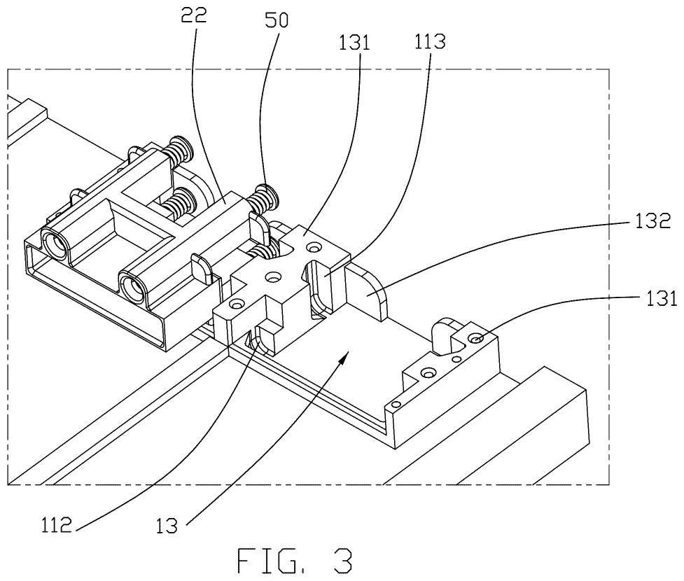

Referring to FIGS. 3-8, the cartridge 10 has plural connector chambers 13 arranged in the first axis thereof to receive the plug connectors 20. Plural guiding cavities 141/142 at opposite sides of the chambers 13 in the first axis, the guiding cavities 141/142 communicate with corresponding the chambers 13 in the second axis perpendicular to the first axis. Each of the chambers 13 has at least one guiding cavity 141/142 at each of two opposite sides thereof in the first axis. The plug connector 20 has at least one guiding rib 241/242 at each of two opposite sides of the plug housing 22 in the first axis. The guiding ribs are received in corresponding guiding cavities. One of the guiding ribs and one corresponding guiding cavity form one guiding mechanism. Each of the cavities converges forwards. A mating side of the electrical connector is defined a front side, for simplify.

Plural biasing assemblies 50 are disposed behind the plug housings 22 to allow the plug connectors 20 to move forward and rearward in the mating axis. The biasing assemblies 50 are operable to forwardly push the plug connectors 20. The guiding cavities 241/242 converge forward so as to permit the plug connector 20 to move in the first axis and the second axis during the plug connector 20 are urged to move by the biasing assemblies 50. Therefore, the plug connector 20 may be movable relative to the cartridge 10 along the first axis and/or along the second axis to accommodate misalignment of the plug connector 20 relative to the receptacle connector 40 in real time. The degree of freedom is all 3-axis free of limited movement and rotation. That is, each plug connector is guided to be constantly adjusted its position so as to get a more precise positioning to secure the alignment of the plug connector and the receptacle connector. Moreover, the mating guides and the conductive elements of adjacent plug connectors are distinct from each other, the impact on each other are reduced.

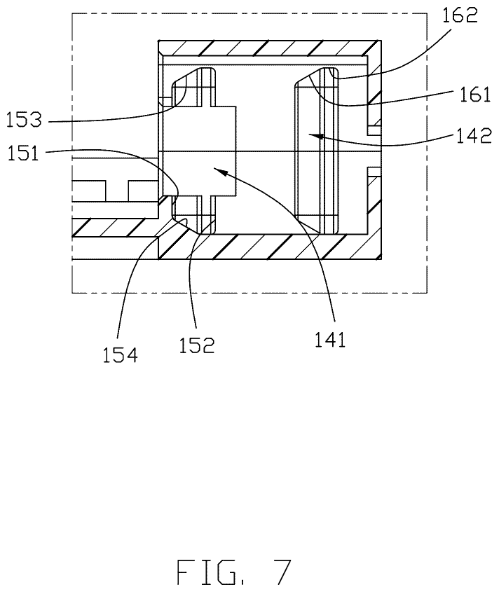

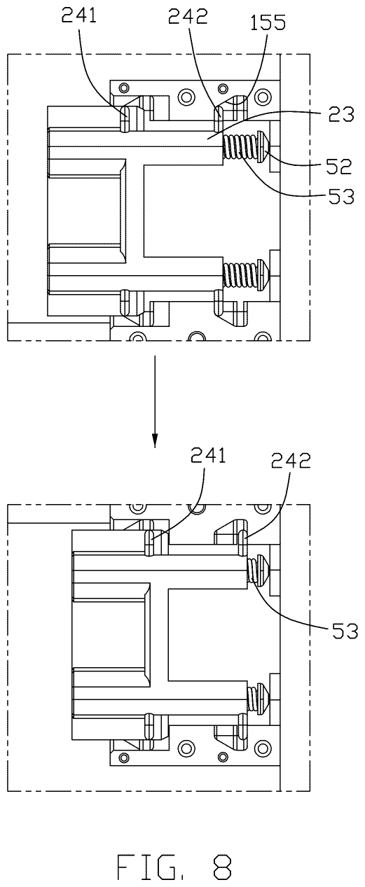

In this embodiment, the cartridge 10 has at least one front guiding cavity 141 and at least one rear guiding cavity 142 at each side of the connector chamber in the first axis. The front and the rear guiding cavities communicate with the connector chambers 13 in the second axis. In this embodiment, the chamber 13 is surrounded with two opposite walls 131. The chambers 13, the cavities 141, 142 are formed with the upper frame 12 and the lower frame 11. The plug connector 20 has at least one front guiding rib 241 and at least one rear guiding rib 242 at each side of the plug housing 22 in the first axis. The front guiding rib 241 is received in the front cavity 141, the rear guiding rib 242 is received in the rear cavity 242. As best shown in FIGS. 7-8, each of the front cavity 241 and the rear cavity 242 is shaped to converge forward. In this embodiment, the engagement of the front and the rear guiding ribs/cavities with the biasing assemblies benefits to get a more precisely control of the floating movement.

Moverover, two front guiding ribs 241 and two rear guiding ribs 242 are disposed on each side of the connector chamber 13 in the first axis. The two front guiding ribs 241 are received in the same front guiding cavity 141 and the two rear guiding ribs 242 are received in the same rear guiding cavity 142. A more precisely control of the floating movement is got. The degree of freedom is all 3-axis free of limited movement and rotation. The plug connector 20 will be at the zero position before mating. The movement of the plug connector 20 in the Y-axis may limit to ±3 mm, in the Z-axis may limit to ±3 mm, in the X-axis limits to +7 mm.

In this embodiment, each of the connector chambers 13 is surrounded with two opposite walls 131. The cartridge has a stop wall 132 at a rear side of the chamber 13. The chambers 13, the guiding cavities 141, 142 are formed with the upper frame 12 and the lower frame 11. The lower fame 11 has plural half-cavities 112, 113 and a rear wall 114, the upper frames 12 has plural half-cavities 122, 123. The half-cavities of the upper frame and the lower frames commonly define the front guiding cavity 141 and the rear guiding cavity 142. Plural retaining pins 115 on the upper frame 12 are inserted and retained into the retaining holes on the lower frames 11.

In this embodiment, plural biasing assemblies 50 are disposed between the plug housing 22 and the rear wall or a portion of the cartridge 10 to urge the plug connectors 20 to move forwards and rearward in the mating axis. Each of the biasing assemblies 50 includes a rod 51 with a nut 52, and a spring member 53. In this embodiment, the spring member 53 is a coil spring. The spring member 53 is set around the rod 51, a rear end of the spring member 53 is blocked at an inside 521 of the nut 52. An outside of the nut offers a dome-shaped surface 522.

In this embodiment, the plug housing 22 has plural supporting posts 23 extending rearwards, and each of the supporting posts 23 has a receiving passage 232 and a supporting pin 231 therein. A front portion of the spring member 53 is received in the receiving passage 232 and is set around the supporting pin 231. Therefore, the biasing assembles 50 can move in the receiving passages 232 in the mating axis to prevent the spring member 53 from dropping from the plug housing 22.

In this embodiment, each of the front cavity 141 and the rear cavity 142 has a front inside 151 and a rear inside 152, an upper inside 153 and a lower inside 154, and a transverse inside 155. Each inside is smoothly connected with each other. Each of the upper inside 153, the lower inside 154 and the transverse inside 155 has a ramp surface 161 to form the converging-forward guiding cavity 141, 142. Therefore, the guiding ribs 241, 242 may move in corresponding guiding cavities 141, 142 along three axes to center the plug connector 10 in an accurate position during mating process of the plug connector 20 with the receptacle connector 40. That is, the upper inside 153 and the lower inside 154 allow the guiding ribs 241, 242 to move in the second axis, and the transverse insides 155 allow the plug connector 20 to move in the first axis. Therefore, a floating and centering mechanism formed with the guiding ribs, the guiding cavities and the biasing assemblies, for mate of electrical connectors is formed between the plug connector and the cartridge, that allows the plug connector to float in three axes.

When the plug connectors 20 are received in corresponding chambers 13, the dome-shaped surface 522 of the nuts 52 abuts against the rear inside of the chamber 13, the guiding ribs 141, 142 are received in corresponding guiding cavities 241, 242. The biasing assembles 50 keep the plug housing 22 in a front position, each of the guiding ribs 241, 242 abuts against the front inside 151 of corresponding guiding cavity in the mating axis. When the tray 30 slides into the cartridge 10, the guiding holes 21 is inserted with the guiding pin 41 firstly, then the conductive elements of the receptacle connector 40 are inserted with the conductive elements of the plug connector 10. During the inserting process of the two conductive elements, the plug housing 22 moves rearwards, the guiding ribs 241, 242 move along the ramp surface 161, thereby keeping the plug housing 22 adjusting in the first axis and the second axis. When the two connectors are mated together, the spring members 53 push the plug housing 22 back to the front position. The plug connectors 20 are all 3-axis free of limited movement and rotation to escape a crash issue. That is, a destroy mating risk and a low cable squeeze risk reduce.

In this embodiment, each of the upper inside 153, the lower inside 154 and the transverse inside 155 has a horizontal surface 162 behind the ramp surface 161, the horizontal surface 162 is connected with the ramp surface 161 and the rear inside 152 of each guiding cavity.

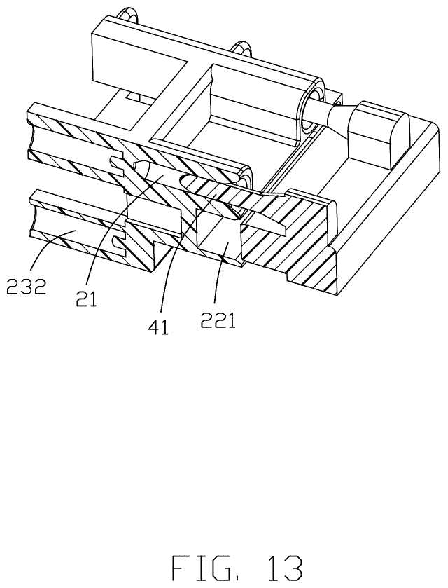

As best shown in FIG. 13, the two guide holes 21 with a long guiding distance are disposed on the plug connector 20 and the two guide pins 41 are disposed on the receptacle connector. The two guide pins 21 have large engaging distance before the plug connector and the receptacle connector are mated.

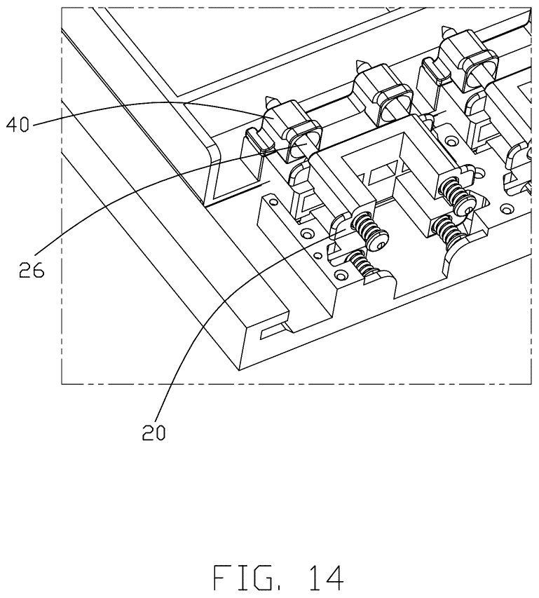

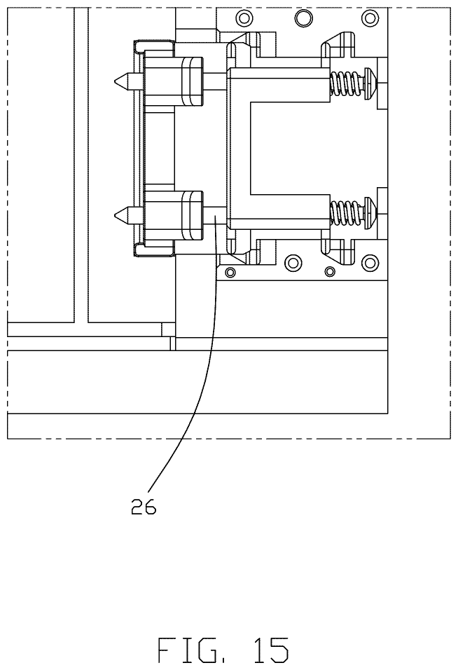

FIGS. 14-15 show a third embodiment, wherein the plug connector 20 has two guiding pins 26 and the receptacle connector 40 has two guiding holes 46.

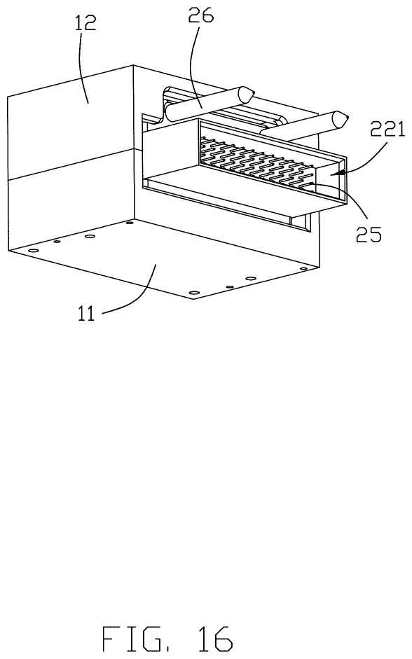

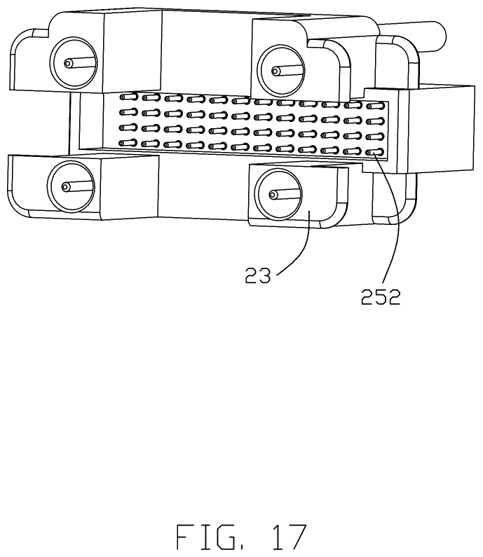

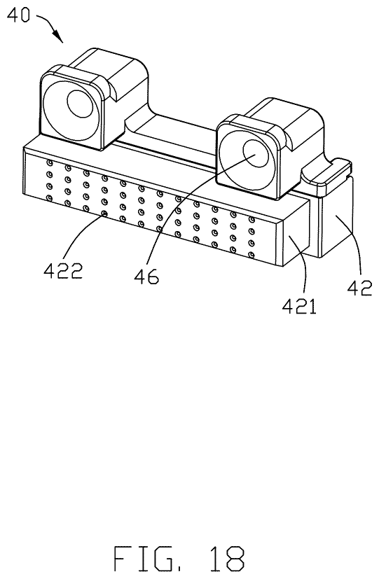

FIGS. 16-18 show a fourth embodiment, which depict a specific plug connector and a specific receptacle connector. The plug connector 20 has a mating cavity 221. The array of conductive elements 25 are arranged in columns and rows, the conductive elements 25 protrude in the mating cavity 221. Two guiding post 26 protrude forwards beyond the mating cavity 221 in the mating axis. Rear ends 252 extend out of the connecting housing 22 to be connected with cables. Seen in the mating axis, the array of conductive elements 25 is located between the four supporting posts 23 and connected with cables extending rearwards. The receptacle connector 40 including the connector housing 42 made from insulating material and conductive elements retained in the connector housing 42. The connector housing 42 include a mating portion 421 and passages 422 running through the mating portion, the conductive elements are received in the passages 422. The mating portion 421 is received in the mating cavity 221 of the plug connector 10

It is noted that the connector housing 22 is made from an insulating material and an array of conductive elements 25 are retained in the connector housing 22. In alternative embodiment, the connector housing 22 can include a distinct housing made from metal material and the distinct housing rigidly encloses the connector housing to form a united element, that is, the distinct housing or frame is immovable relative to the connector housing 22. The guiding pins can be integrally extending front the metallic distinct housing.

Although the present invention has been described with reference to particular embodiments, it is not to be construed as being limited thereto. Various alterations and modifications can be made to the embodiments without in any way departing from the scope or spirit of the present invention as defined in the appended claims.

1. A cartridge comprising:
a plurality of connector chambers arranged in a first axis;
a plurality of electrical connectors received in the connector chambers respectively, each of the electrical connectors having a mating axis and comprising a connector housing, an array of conductive elements retained in the connector housing, and a mating guide immovably disposed on the connector housing; and
at least one biasing assembly disposed behind each of the electrical connectors and pushing forwards the electrical connector in the mating axis;
wherein the cartridge further comprises plural guiding mechanisms, each of the guiding mechanisms allows a corresponding connector housing to move in the first axis and a second axis perpendicular to the first axis.

2. The cartridge as claimed in claim 1, wherein:
the cartridge has at least one guiding cavity at each of two opposite sides of the connector chamber in the first axis;
each of the electrical connectors has at least one guiding rib at each of two opposite sides of the connector housing in the first axis, the guiding rib is received in the guiding cavity;
the guiding cavity has a front inside, a rear inside, an upper inside, a lower side, and a transverse inside connected with the front inside, the rear inside, the upper inside and the lower inside; and
each of the upper inside, the lower inside, and the transverse inside has a ramp surface to converge the guiding cavity forwards.

3. The cartridge as claimed in claim 1, wherein:
the cartridge has a front guiding cavity and a rear guiding cavity at each of the opposite two sides of the connector chamber;
each of the electrical connector has two front guiding ribs and two rear guiding ribs at each of the opposite sides of the electrical connector, the two front guiding ribs are received in the front guiding cavity, and the two rear guiding ribs are received in the rear guiding cavity;
each of the front guiding cavity and the rear guiding cavity has a front inside, a rear inside, an upper inside, a lower side, and a transverse inside connected with the front inside, the rear inside, the upper inside, and the lower inside; and
each of the upper inside, the lower inside, and the transverse inside has a ramp surface.

4. The cartridge as claimed in claim 3, wherein the upper inside, the lower inside and the transverse inside of each of the front cavity and the rear cavity converge forwards.

5. The cartridge as claimed in claim 4, wherein each of the front inside and the rear inside is a plan surface.

6. The cartridge as claimed in claim 5, wherein each of the upper inside, the lower inside, and the transverse inside has a horizontal surface connecting with the ramp surface and the rear inside.

7. The cartridge as claimed in claim 1, wherein the at least one biasing assembly has a dome-shaped surface at a rear end thereof, a front end of the biasing assembly pushes against the connector housing, the dome-shaped surface push against a portion of the cartridge.

8. The cartridge as claimed in claim 7, wherein:
the at least one biasing assembly comprises a rod with a nut, and a spring member;
an outside of the nut has the dome-shaped surface; and
the spring member is set around the rod.

9. The cartridge as claimed in claim 8, wherein the connector housing has four supporting posts extending rearward, each of the four supporting posts having a receiving passage, and a front portion of the spring member is received in the receiving passage.

10. The cartridge as claimed in claim 9, wherein the supporting post has a supporting pin in the receiving passage, and the front portion of the spring member is set around the supporting pin.

11. The cartridge as claimed in claim 10, wherein, viewed in the mating axis, the array of conductive elements is located between the four supporting posts and connected with cables extending rearwards.

12. The cartridge as claimed in claim 1, wherein the mating guide is a guiding pin or a guiding hole.

13. The cartridge as claimed in claim 1, further comprising a lower frame and an upper frame disposed in the second axis and assembled together, and wherein the connector chambers are formed between the upper frame and the lower frame.

14. A cartridge for being loaded with at least one electrical connector defining a mating axis and having guiding ribs and for at least one biasing assembly to forward push the at least one electrical connector, the cartridge comprising:
at least one connector chamber for receiving the at least one electrical connector, the at least one connector chamber having two opposite sides in a first axis perpendicular to the mating axis; and
at least one guiding cavity disposed at each of the two opposite sides of the at least one connector chamber;
wherein the at least guiding cavity converges forwards to allow corresponding guiding rib of the at least one electrical connector to move in the first axis and a second axis perpendicular to the first axis during movement of the at least one electrical connector in the mating axis.

15. The cartridge as claimed in claim 14, wherein:
the at least one guiding cavity has a front inside, a rear inside, an upper inside, a lower inside, and a transverse inside connected with the front inside, the rear inside, the upper inside, and the lower inside;
each of the upper inside and the lower inside has a ramp surface towards each other at a front end thereof; and
each of two opposite transverse insides has a ramp surface towards each other at a front end thereof.

16. The cartridge as claimed in claim 15, wherein the at least one guiding cavity comprises a front guiding cavity and a rear guiding cavity.

17. A cartridge comprising:
a plurality of connector chambers arranged in a first axis;
a front guiding cavity and a rear guiding cavity both at each of two opposite sides of each of the connector chambers in the first axis;
a plurality of electrical connectors received in the connector chambers respectively, each of the electrical connectors having a mating axis and comprising a connector housing, an array of conductive elements retained in the connector housing, two front guiding ribs at each of two opposite sides of the connector housing in the first axis and received in the front guiding cavity, and two rear guiding ribs at each of the two opposite sides of the connector housing and received in the rear guiding cavity; and
at least one biasing assembly disposed behind each of the electrical connectors and forwards pushing the electrical connector in the mating axis;
wherein each of the guiding cavities converges forwards.
